(19) United States
(12) Patent Application Publication
(10) Pub. No.: US 2017/0152707 A1
(43) Pub. Date: Jun. 1, 2017

(54) Expandable Ladder Assembly

(71) Applicant: Edward Marrow, Setauket, NY (US)

(72) Inventor: Edward Marrow, Setauket, NY (US)

(21) Appl. No.: 15/362,789

(22) Filed: Nov. 28, 2016

Related U.S. Application Data
(60) Provisional application No. 62/260,409, filed on Nov. 27, 2015.

(51) Int. Cl. E06C 1/12; E06C 7/46; E06C 7/08

(52) U.S. Cl. CPC E06C 1/12; E06C 7/08; E06C 7/46

(57) ABSTRACT

A ladder assembly for accommodating a variety of spaces is provided. The ladder assembly comprises a first rail having a top end and a bottom end and a second rail having a top end and a bottom end. The second rail is spaced from the first rail. A plurality of spaced rungs are mounted between the first rail and the second rail with each rung having a first rung portion and a second rung portion. Each first rung portion is slidably receivable within the corresponding second rung portion allowing the first rail and the second rail to be moved in a general direction toward and away from each other and a distance between the first rail and the second rail to be adjusted to accommodate the desired space.

### CLAIM OF PRIORITY

This patent application claims priority under 35 USC 119 (e) (1) from U.S. Provisional Patent Application Ser. No. 62/260,409 filed Nov. 27, 2015, of common inventorship herewith entitled, “L 3000 Ladder,” which is incorporated herein by reference as though the same were set forth in its entirety.

### FIELD OF THE INVENTION

The present invention pertains to the field of home and construction tools, and more specifically to the field of ladders.

### BACKGROUND OF THE INVENTION

Many individuals including construction tradesmen, general handymen and homeowners rely on a ladder to get them to the level of their work. Conventional rigid ladders are a fixed width which often creating instability and provides lithe versatility in fitting into different sized spaces.

The prior art has put forth several designs for ladders. Among these are:

U.S. Pat. No. 8,381,877 to Paul E. Freund describes a ladder assembly consisting of a plurality of ladder segments each comprising a pair of identical rails. A third rail is disposed medially between the parallel rails but not in the same plane. A plurality of rungs form steps perpendicularly positioned and attached to the parallel rails but each is diverted medially to attach to the third rail. A plurality of joints are sized to join each segment end on end to form the assembly. In any ladder assembly having at least three segments, one of the third rails in the assembly is shorter than the other rails.

U.S. Pat. No. 4,489,807 to Ernest A. Rodriquez describes a contractible escape ladder, configured for deployment from a collapsed configuration outwardly proximate a wall of a building structure to an escape configuration. The ladder is comprised of first and second ladder rails pivotal about a plurality of ladder rungs bridging same and nestable interiorly thereof. A latching member maintains rails juxtaposed one to another in the collapsed configuration. A latch release pin traverses the wall for deployment of the ladder from a position inside the building while maintaining the ladder secure from positions outside the building.

U.S. Pat. No. 3,024,864 to Thelma E. Padlo describes a folding ladder comprising spaced vertical side members. A plurality of rungs extend between the members in vertically spaced relationship. Pivotal connections connect each of the rungs to each of the side members. The rungs each have a channel shape with the open side of the channel facing downwardly and the bottom of the channel providing the top of the rung. The rungs are tapered from a given width adjacent one of the side members to a narrower width adjacent the other of the side members. The rungs are spaced from each other a distance less than the length of the rungs and the wider portion of each rung, receiving the narrower portion of the adjacent rung upon the swinging of the rungs about the connections to move the members toward each other.

None of these prior art references describe the present invention.

### SUMMARY OF THE INVENTION

It is an object of the present invention to provide a rigid ladder in which the two vertical railings of the ladder are movable to a space accommodating width by means of adjustable horizontal rungs which are extendable or retractable between the railings.

The present invention is a ladder assembly for accommodating a variety of spaces. The ladder assembly comprises a first rail having a top end and a bottom end and a second rail having a top end and a bottom end. The second rail is spaced from the first rail. A plurality of spaced rungs are mounted between the first rail and the second rail with each rung having a first rung portion and a second rung portion. Each first rung portion is slidably receivable within the corresponding second rung portion allowing the first rail and the second rail to be moved in a general direction toward and away from each other and a distance between the first rail and the second rail to be adjusted to accommodate the desired space.

In addition, the present invention is a method for accommodating a variety of spaces with a ladder. The method comprises providing a first rail having a top end and a bottom end, providing a second rail having a top end and a bottom end, spacing the second rail from the first rail, mounting a plurality of spaced rungs between the first rail and the second rail, each rung having a first rung portion and a second rung portion, slidably inserting each first rung portion into the corresponding second rung portion, moving the first rail and the second rail in a general direction toward and away from each other, and adjusting a distance between the first rail and the second rail to accommodate the desired space.

The present invention further includes a ladder assembly for accommodating a variety of spaces. The ladder assembly comprises a first rail having a top end and a bottom end and a second rail having a top end and a bottom end. The second rail is spaced from the first rail. A plurality of spaced rungs are mounted between the first rail and the second rail with each rung having a first rung portion and a second rung portion. A locking mechanism releasably secures a desired distance between the first rail and the second rail. The first rung portion is completely receivable within the second rung portion such that the second rung portion is capable of spanning the entire space between the first rail and the second rail. Each first rung portion is slidably receivable within the corresponding second rung portion allowing the first rail and the second rail to be moved in a general direction toward and away from each other and a distance between the first rail and the second rail to be adjusted to accommodate the desired space.

### BRIEF DESCRIPTION OF THE DRAWINGS

FIG. 1 is a perspective view illustrating a ladder of an expandable ladder assembly, constructed in accordance with the present invention, with the ladder shown in a narrowed configuration to accommodate a narrow space.

FIG. 2 is another perspective view illustrating a ladder of an expandable ladder assembly, constructed in accordance with the present invention, with the ladder shown in a narrowed configuration to accommodate a narrow space.

FIG. 3 is a perspective view illustrating a ladder of an expandable ladder assembly, constructed in accordance with the present invention, with the ladder shown in a widened configuration to accommodate a wide space.

FIG. 4 is another perspective view illustrating a ladder of an expandable ladder assembly, constructed in accordance with the present invention, with the ladder shown in a widened configuration to accommodate a wide space.

FIG. 5 is a close up perspective view illustrating a plurality of rungs of the ladder of the expandable ladder assembly, constructed in accordance with the present invention, showing top rungs which are adjustable in width to accommodate different size spaces.

FIG. 6 is a close up perspective view illustrating a pair of padded feet of the ladder of the expandable ladder assembly, constructed in accordance with the present invention, showing the adjustable rubber padded feet at the bottom end below the last rung of the ladder.

FIG. 7 is a sectional side view illustrating a locking mechanism of the expandable ladder assembly, constructed in accordance with the present invention, with locking mechanism being a lever operated lock.

FIG. 8 is a top plan view illustrating a locking mechanism of the expandable ladder assembly, constructed in accordance with the present invention, with the locking mechanism being a series of apertures for receiving a nub or the like.

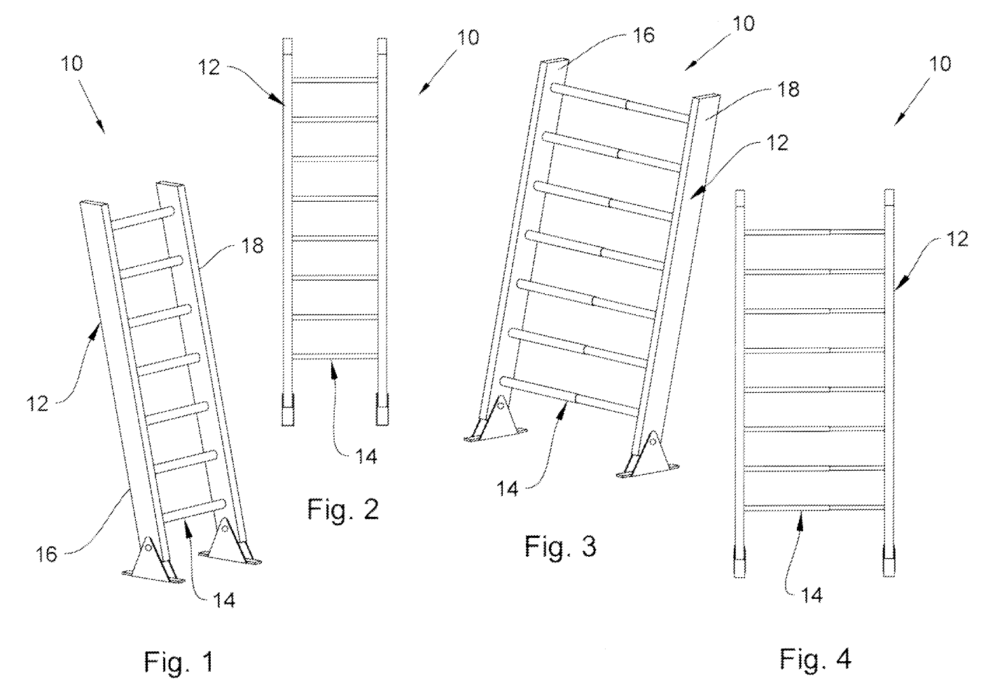

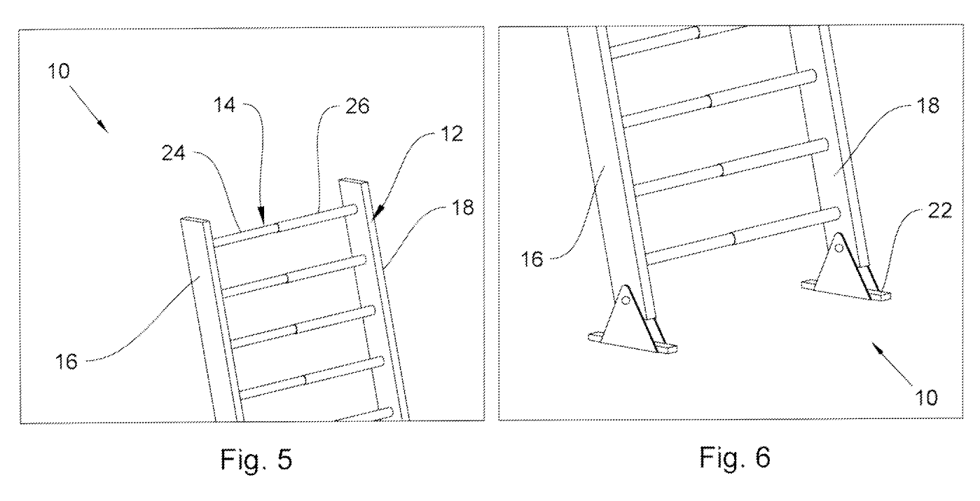

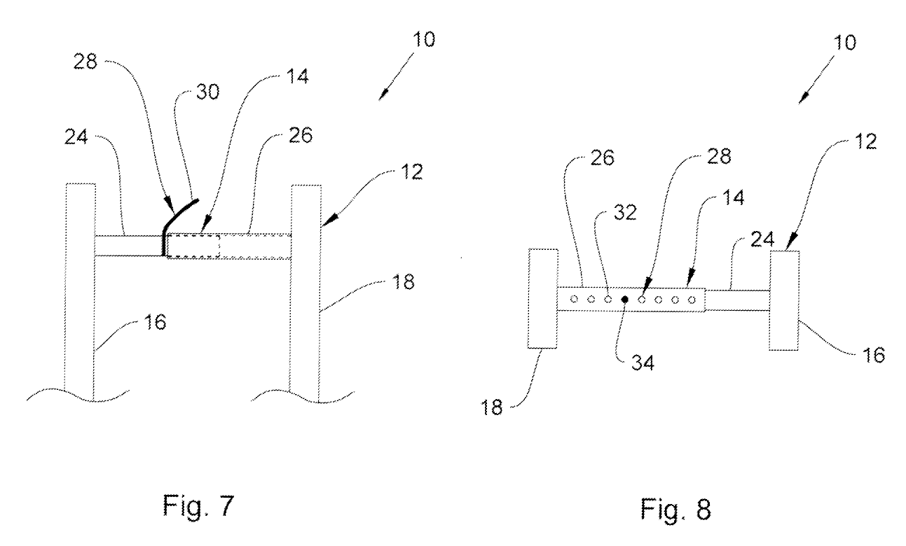

### DETAILED DESCRIPTION OF THE INVENTION

The present invention, hereinafter referred to as an Expandable Ladder Assembly, indicated generally at 10, providing is a rigid ladder 12 in which the two vertical railings of the ladder are movable to a space accommodating width by means of adjustable horizontal rungs 14 which are extendable or retractable between a pair of railings 16, 18 of the ladder 12. More stable and supportive than conventional rigid ladders, the ladder 12 of the Expandable Ladder Assembly provide greater versatility as the width of the ladder 12 is easily adaptable to fit a space in which it is used. The ladder 12 provides greater stability by giving workers more space to move laterally while working from the ladder 12.

As stated, the ladder 12 of the Expandable Ladder Assembly 10 of the present invention has a first rail 16 and a second rail 18 spaced from the first rail 16 by a plurality of rungs 14. The first rail 16 has a top end and a bottom end and the second rail 18 has a top end and a bottom end. Preferably, the ladder 12 is constructed in lengths of approximately four (4′) feet, six (6) feet, eight (8′) feet, and ten (10″) feet. Preferably constructed from an aluminum or fiberglass material, the ladder 12 can be, but not necessarily wider at a base than at a top of the ladder 12.

In addition, the ladder 12 of the Expandable Ladder Assembly 10 of the present invention includes a first padded foot 20 mounted to the bottom end of the first rail 16 and a second padded foot 22 mounted to the bottom end of the second rail 18. Preferably, each foot 20, 22 is swivelly attached to the bottom ends of the first rail 16 and the second rail 18, respectively allowing the feet 20, 22 to rest flat against a ladder supporting surface regardless of the ladder angle. Also, it is preferably that each foot 20, 22 is padded in a resilient material, such as rubber, to prevent marring and disfiguration of the ladder supporting surface.

Each rung 14 of the ladder 12 of the Expandable Ladder Assembly includes a first rung portion 24 and a second rung portion 26. The first rung portion 24 is slidably receivable within the second rung portion 26 allowing the width of the ladder 12 to be adjusted to accommodate the desired space. In order to accommodate the first rung portion 24 being slidable into the second rung portion 26, the first rung portion 24 and the second rung portion 26 are preferably tubular allowing the first rung portion 24 to completely enter the second rung portion 26. Basically, the first rung portion 24 is completely received within the second rung portion 26 such that the second rung portion 26 spans the entire space between the first rail 16 and the second rail 18.

In another preferred embodiment, the first rung portions 24 of the ladder of the Expandable Ladder Assembly 10 of the present invention can be tubular or solid and the second rung portions 26 preferably are flat topped, tubular rungs of a slightly larger diameter which slide on and over the smaller diameter, solid and tubular first rung portions 24 when the ladder 12 is assembled during manufacture. The flat top surface second rung portions 26 are thicker than round rungs typically found on a conventional rigid ladder.

Furthermore, the Expandable Ladder Assembly 10 of the present invention includes a locking mechanism 28 for releasably securing the desired width of the ladder 12. Preferably, the Expandable Ladder Assembly 10 has a pair of locking mechanisms 28. One of the locking mechanisms 28 is positioned at least at the rung 14 most nearingly adjacent the top end of the rails 16, 18 and the other locking mechanism 28 is positioned at the rung 14 most near ugly adjacent the bottom end of the rails 16, 18. It is within the scope of the present invention to have a plurality of locking mechanisms 28 with more than two locking mechanisms 28 up to and including all of the rungs 14 having a locking mechanism 28.

In an embodiment of the present invention, the locking mechanism 28 of the Expandable Ladder Assembly 10 of the present invention is a lever operated lock 30 located at the open end of the larger diameter, flat topped second rung portions 26. The lever operated lock 30 releasably secures the first rung portion 24 to the second rung portions 26 at any lateral extension thereby maintaining the desired width of the ladder 12.

In another embodiment of the present invention, the locking mechanism 28 of the Expandable Ladder Assembly 10 of the present invention includes a plurality of apertures 32 formed in the second rung portion 26 and a nub 34 or the like formed on the first rung portion 24. The nub 34 of the first rung portion 24 is releasably receivable within one of the apertures 32 thereby releasably securing the first rung portion 24 to the second rung portion 26 and maintaining the desired width of the ladder 12.

In still another embodiment of the present invention, the locking mechanism 28 of the Expandable Ladder Assembly 10 of the present invention includes friction between the first rung portion 26 and the second rung portion 28. The friction between the first rung portion 26 and the second rung portion 28 releasably secures the first rung portion 26 to the second rung portion 28 and maintains the desired width of the ladder 12.

Using and adjusting the Expandable Ladder Assembly 10 of the present invention is simple and straightforward. To increase the width of the ladder 12 of the Expandable Ladder Assembly 10, a user releases the locking mechanism 28 on the releasably locked rung 14 and pulls the rails 16, 18 out to a desired width. The user then quickly locks each locking mechanism 28 to secure the second rung portion 26 to the first rung portion 24 at the desired extension. The ladder 12 of the Expandable Ladder Assembly 10 is secure and ready to raised and balanced against a wall or wherever the user needs to climb higher.

The ladder 12 of the Expandable Ladder Assembly 10 of the present invention can be set up at its minimum width like an ordinary ladder or in a relatively wider space, the rails 16, 18 and rungs 14 can be extended. Extending the width of the rails 16, 18 and rungs 14 provides more space for working laterally from the ladder 12 and also creates a wider, more stable and supportive footing for the base of the ladder 12. With its relatively broad and flat rungs 14, the ladder 12 is easy on a worker's feet and make easy for a worker to balance while performing their work. The ladder 12 is lightweight providing quick and easy setup, adjustment, transport, and storage. Safely engineered and durably constructed of high quality materials, the ladder 12 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A ladder assembly for accommodating a variety of spaces, the ladder assembly comprising:
a first rail having a top end and a bottom end;
a second rail having a top end and a bottom end, the second rail spaced from the first rail; and
a plurality of spaced rungs mounted between the first rail and the second rail, each rung having a first rung portion and a second rung portion;
wherein each first rung portion is slidably receivable within the corresponding second rung portion allowing the first rail and the second rail to be moved in a general direction toward and away from each other and a distance between the first rail and the second rail to be adjusted to accommodate the desired space.

2. The ladder assembly of claim 1 wherein a distance between the top end of the first rail and the top end of the second rail is less than a distance between the bottom end of the first rail and the bottom end of the second rail.

3. The ladder assembly of claim 1 and further comprising:
a first padded foot mounted to the bottom end of the first rail; and
a second padded foot mounted to the bottom end of the second rail.

4. The ladder assembly of claim 3 wherein each foot is swivelly attached to the bottom ends of the first rail and the second rail allowing the foot to rest flat against a ladder supporting surface regardless of a ladder angle.

5. The ladder assembly of claim 3 wherein each foot is padded a resilient material.

6. The ladder assembly of claim 1 wherein the first rung portion and the second rung portion are tubular allowing the first rung portion to completely enter the second rung portion.

7. The ladder assembly of claim 6 wherein the first rung portion is completely receivable within the second rung portion such that the second rung portion is capable of spanning the entire space between the first rail and the second rail.

8. The ladder assembly of claim 1 wherein the first rung portions are solid.

9. The ladder assembly of claim 1 wherein the second rung portions have a substantially flat top surface.

10. The ladder assembly of claim 1 and further comprising:
a locking mechanism for releasably securing a desired distance between the first rail and the second rail.

11. The ladder assembly of claim 10 and further comprising:
a pair of locking mechanisms;
wherein one of the locking mechanisms is positioned at the rung most nearingly adjacent the top end of the rails and the other locking mechanism is positioned at the rung most nearingly adjacent the bottom end of the rails.

12. The ladder assembly of claim 10 wherein each of the rungs has a locking mechanism.

13. The ladder assembly of claim 10 wherein the locking mechanism is a lever operated lock positioned near an open end of the second rung portion for releasably securing the first rung portion to the second rung portion.

14. The ladder assembly of claim 10 wherein the locking mechanism is a plurality of apertures formed in the second rung portion and a nub or the like formed on the first rung portion, the nub of the first rung portion releasably receivable within one of the apertures.

15. The ladder assembly of claim 10 wherein the locking mechanism is friction between the first rung portion and the second rung portion.

16. A method for accommodating a variety of spaces with a ladder, the method comprising:
providing a first rail having a top end and a bottom end;
providing a second rail having a top end and a bottom end;
spacing the second rail from the first rail;
mounting a plurality of spaced rungs between the first rail and the second rail, each rung having a first rung portion and a second rung portion;
slidably inserting each first rung portion into the corresponding second rung portion;
moving the first rail and the second rail in a general direction toward and away from each other; and
adjusting a distance between the first rail and the second rail to accommodate the desired space.

17. A ladder assembly for accommodating a variety of spaces, the ladder assembly comprising:
a first rail having a top end and a bottom end;
a second rail having a top end and a bottom end, the second rail spaced from the first rail;
a plurality of spaced rungs mounted between the first rail and the second rail, each rung having a first rung portion and a second rung portion; and
a locking mechanism for releasably securing a desired distance between the first rail and the second rail;
wherein the first rung portion is completely receivable within the second rung portion such that the second rung portion is capable of spanning the entire space between the first rail and the second rail; and
wherein each first rung portion is slidably receivable within the corresponding second rung portion allowing the first rail and the second rail to be moved in a general direction toward and away from each other and a distance between the first rail and the second rail to be adjusted to accommodate the desired space.

18. The ladder assembly of claim 17 and further comprising:
a first padded foot mounted to the bottom end of the first rail; and
a second padded foot mounted to the bottom end of the second rail;
wherein each foot is swivelly attached to the bottom ends of the first rail and the second rail allowing the foot to rest flat against a ladder supporting surface regardless of a ladder angle.

19. The ladder assembly of claim 12 and further comprising:
a pair of locking mechanisms:
wherein one of the locking mechanisms is positioned at the rung most nearingly adjacent the top end of the rails and the other locking mechanism is positioned at the rung most nearingly adjacent the bottom end of the rails.

20. The ladder assembly of claim 17 wherein the looking mechanism is a lever operated lock positioned near an open end of the second rung portion for releasably securing the first rung portion to the second rung portion.
